(19) United States
(12) Patent Application Publication
(10) Pub. No.: US 2025/0074309 A1
(43) Pub. Date: Mar. 6, 2025

(54) VEHICULAR INTERIOR REARVIEW MIRROR ASSEMBLY WITH ELECTRIFICATION OF ELECTROCHROMIC MIRROR

(71) Applicant: Magna Mirrors of America, Inc., Holland, MI (US)

(72) Inventors: Nathan C. Shipaila, Rockford, MI (US); Alexander J. Reau, Wyoming, MI (US); Kyle R. Bosch, Holland, MI (US)

(21) Appl. No.: 18/820,513

(22) Filed: Aug. 30, 2024

Related U.S. Application Data
(60) Provisional application No. 63/604,231, filed on Nov. 30, 2023.
(60) Provisional application No. 63/580,464, filed on Sep. 5, 2023.

(51) Int. Cl. B60R 1/08; B60R 1/04

(52) U.S. Cl. CPC B60R 1/088; B60R 1/04

(57) ABSTRACT

A vehicular electrochromic interior rearview mirror assembly includes a mirror head that accommodates an electrochromic mirror reflective element. The electrochromic mirror reflective element includes an electrochromic medium disposed between a front glass substrate and a rear glass substrate. A first electrically conductive connector is disposed at least partially within the perimeter seal and extends along a first portion of a peripheral edge region of the mirror reflective element and electrically conductively connects a transparent electrically conductive coating at the front glass substrate to a first electrical connector at the rear glass substrate. A second electrically conductive connector is disposed at least partially within the perimeter seal and extends along a second portion of the peripheral edge region of the mirror reflective element and electrically conductively connects an electrically conductive coating at the rear glass substrate to a second electrical connector at a rear side of the rear glass substrate.

### CROSS REFERENCE TO RELATED APPLICATIONS

The present application claims the filing benefits of U.S. provisional application Ser. No. 63/604,231, filed Nov. 30, 2023, and U.S. provisional application Ser. No. 63/580,464, filed Sep. 5, 2023, which are hereby incorporated herein by reference in their entireties.

### FIELD OF THE INVENTION

The present invention relates generally to the field of interior rearview mirror assemblies for vehicles.

### BACKGROUND OF THE INVENTION

It is known to provide a mirror assembly that is adjustably mounted to an interior portion of a vehicle, such as via a single ball pivot or joint mounting configuration or double ball pivot or joint mounting configuration where the mirror casing and reflective element are adjusted relative to the interior portion of a vehicle by pivotal movement about the single or double ball pivot configuration. The mirror reflective element may comprise an electrochromic mirror reflective element comprising a front glass substrate and a rear glass substrate with an electrochromic medium sandwiched between the glass substrates and bounded by a perimeter seal.

### SUMMARY OF THE INVENTION

An interior rearview mirror assembly, such as a vehicular electrochromic rearview mirror assembly, includes a mounting structure configured to attach at an interior portion of a cabin of a vehicle equipped with the vehicular electrochromic rearview mirror assembly. A mirror head accommodates an electrochromic mirror reflective element. With the mounting structure attached at the interior portion of the cabin of the vehicle, the mirror head is adjustable by a driver of the vehicle to set a rearward view for the driver. The electrochromic mirror reflective element includes a front glass substrate having a first side and a second side separated from the first side by a thickness of the front glass substrate. The electrochromic mirror reflective element includes a rear glass substrate having a third side and a fourth side separated from the third side by a thickness of the rear glass substrate. A mirror reflector is disposed at the rear glass substrate. A transparent electrically conductive coating is disposed at the second side of the front glass substrate. An electrically conductive coating is disposed at the third side of the rear glass substrate. The electrochromic mirror reflective element includes an electrochromic medium disposed between the front glass substrate and the rear glass substrate and bounded by a perimeter seal. The perimeter seal extends between the second side of the front glass substrate and the third side of the rear glass substrate along a peripheral edge region of the electrochromic mirror reflective element. The electrochromic medium is in electrical conductive contact with the transparent electrically conductive coating disposed at the second side of the front glass substrate and with the electrically conductive coating disposed at the third side of the rear glass substrate. A first electrically conductive connector extends along a first portion of the peripheral edge region of the electrochromic mirror reflective element and electrically conductively connects between the transparent electrically conductive coating at the second side of the front glass substrate and a first electrical connector at the fourth side of the rear glass substrate. A second electrically conductive connector extends along a second portion of the peripheral edge region of the electrochromic mirror reflective element and electrically conductively connects between the electrically conductive coating at the third side of the rear glass substrate and a second electrical connector at the fourth side of the rear glass substrate. The first electrically conductive connector is disposed at least partially within the perimeter seal along the first portion of the peripheral edge region of the electrochromic mirror reflective element. The second electrically conductive connector is disposed at least partially within the perimeter seal along the second portion of the peripheral edge region of the electrochromic mirror reflective element. The first portion of the perimeter seal is spaced from the second portion of the perimeter seal.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior rearview mirror assembly;

FIG. 2 is a sectional view of the mirror reflective element of the mirror assembly of FIG. 1;

FIG. 3 is a plan view of a rear glass substrate of the mirror reflective element of the mirror assembly of FIG. 1;

FIG. 4 is a plan view of a front glass substrate of the mirror reflective element of the mirror assembly of FIG. 1;

FIG. 5 is a plan view of the mirror reflective element of the mirror assembly of FIG. 1;

FIGS. 6-9 are views of the rear glass substrate of the mirror reflective element of the mirror assembly of FIG. 1;

FIG. 10 is a sectional view of a mirror reflective element having a flexible printed circuit (FPC) between the front glass substrate and the rear glass substrate;

FIG. 11A is a plan view of the mirror reflective element with the FPC when viewing the first surface of the front glass substrate; and

FIG. 11B is a plan view of the mirror reflective element with the FPC when viewing the fourth surface of the rear glass substrate.

### DESCRIPTION OF THE PREFERRED EMBODIMENTS

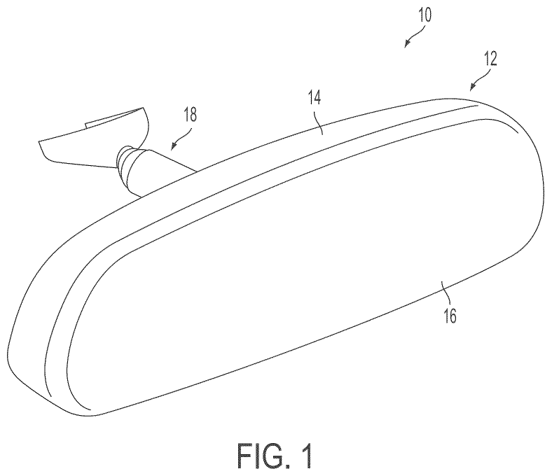

Referring now to the drawings and the illustrative embodiments depicted therein, a vehicular interior rearview mirror assembly 10 includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element includes a variable reflectance mirror reflective element that varies its reflectance responsive to electrical current applied to conductive coatings or layers of the reflective element.

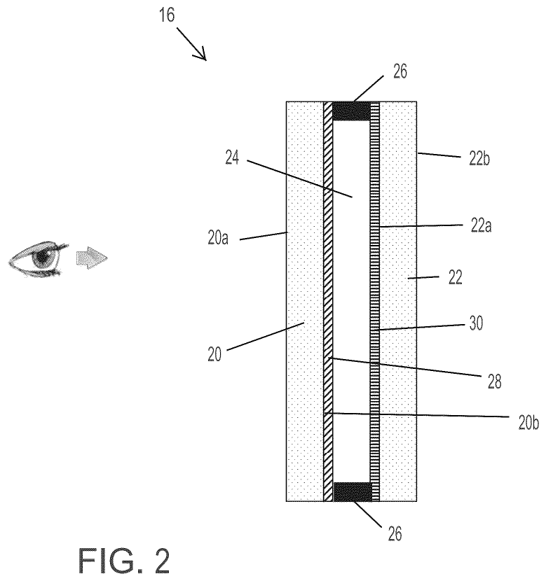

In the illustrated embodiment, and as shown in FIG. 2, the mirror reflective element 16 comprises a laminate construction variable reflectance electro-optic (such as electrochromic) reflective element assembly having a front substrate 20 and a rear substrate 22 with an electro-optic medium 24 (such as electrochromic medium) sandwiched therebetween and bounded by a main seal or perimeter seal 26. As shown in FIG. 2, the front substrate 20 has a front or first surface 20a (the surface that generally faces the driver of a vehicle when the mirror assembly is normally mounted at the vehicle) and a rear or second surface 20b opposite the front surface 20a, and the rear substrate 22 has a front or third surface 22a and a rear or fourth surface 22b opposite the front surface 22a, with the electro-optic medium 24 disposed between the second surface 20b and the third surface 22a and bounded by the perimeter seal 26 of the reflective element. The second surface 20b of the front glass substrate 20 has a transparent conductive coating 28 established thereat (such as an indium tin oxide (ITO) layer, or a doped tin oxide layer or any other transparent electrically semi-conductive layer or coating or the like (such as indium cerium oxide (ICO), indium tungsten oxide (IWO), or indium oxide (IO) layers or the like or a zinc oxide layer or coating, or a zinc oxide coating or the like doped with aluminum or other metallic materials, such as silver or gold or the like, or other oxides doped with a suitable metallic material or the like, or such as disclosed in U.S. Pat. No. 7,274,501, which is hereby incorporated herein by reference in its entirety), while the third surface 22a of the rear glass substrate 22 has a metallic reflector coating 30 (or multiple layers or coatings) established thereat. The front or third surface 22a of the rear substrate 22 may include one or more transparent semi-conductive layers (such as an ITO layer or the like), and one or more metallic electrically conductive layers (such as a layer of silver, aluminum, chromium or the like or an alloy thereof), and may include multiple layers such as disclosed in U.S. Pat. Nos. 7,274,501; 7,184,190 and/or 7,255,451, which are hereby incorporated herein by reference in their entireties. The mirror reflector may comprise any suitable coatings or layers, such as a transflective coating or layer, such as described in U.S. Pat. Nos. 7,626,749; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties, disposed at the front surface of the rear substrate (commonly referred to as the third surface of the reflective element) and opposing the electro-optic medium, such as an electrochromic medium disposed between the front and rear substrates and bounded by the perimeter seal (but optionally, the mirror reflector could be disposed at the rear surface of the rear substrate (commonly referred to as the fourth surface of the reflective element).

The third surface 22a defines the active EC area or surface of the rear substrate within the perimeter seal 26. The coated third surface 22a may also be coated to define a tab-out region (such as by utilizing aspects of the mirror assemblies described in U.S. Pat. Nos. 7,274,501; 7,184,190 and/or 7,255,451, which are hereby incorporated herein by reference in their entireties) for providing electrical connection of the conductive layers to an electrical clip of connector or bus-bar, such as the types described in U.S. Pat. Nos. 5,066,112 and 6,449,082, which are hereby incorporated herein by reference in their entireties.

The mirror assembly may comprise a frameless mirror assembly, where the front glass substrate may have an exposed rounded perimeter glass edge that provides a curved transition from the planar first surface of the front glass substrate to an outer less curved surface of the mirror casing (such as by utilizing aspects of the mirror assemblies described in U.S. Pat. Nos. 9,827,913; 9,174,578; 8,508,831; 8,730,553; 9,598,016 and/or 9,346,403, which are hereby incorporated herein by reference in their entireties). Optionally, the mirror assembly may include a casing portion that circumscribes the perimeter glass edge of the front glass substrate and provides the curved transition from the planar first surface of the front glass substrate to an outer less curved surface of the mirror casing, with the mirror casing portion not encroaching onto or overlapping the planar front or first surface of the front glass substrate (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties).

Frameless mirrors may use an offset between the front or first substrate and the rear or second substrate to achieve mounting and electrification. That is, the front substrate is overlaid at the rear substrate so that a perimeter edge region or overhang region of the front substrate extends beyond an outer peripheral edge of the rear substrate (in some applications, no part of the rear glass substrate extends to or beyond any peripheral part of the front glass substrate, such that the edges of the front glass substrate extend beyond the edges of the front glass substrate). Optionally, the front substrate and the rear substrate may be substantially equally sized such that the perimeter edges of the respective substrates are substantially aligned along the outer edge of the mirror reflective element.

Electrical connectors (e.g., electrically conductive coatings or layers and/or electrically conductive epoxy material or the like) extend along the peripheral edges of the rear substrate toward the second surface of the front substrate to electrically connect a power source to the conductive layers at the third surface of the rear substrate and/or the second surface of the front substrate. The mirror reflective element attaches at the mirror casing via any suitable means, such as, for example, via snap attachment of a mirror backing plate that is adhered at the fourth surface of the rear glass substrate to the mirror casing, or optionally via an adhesive disposed between the second surface of the front substrate and a surface of the mirror casing and/or an adhesive disposed between the fourth surface of the rear substrate and a surface of the mirror casing. A chrome or reflective band is deposited on the second surface of the front substrate to conceal the portion of the housing, the perimeter seal, and the electrical connectors that extend along the peripheral edge of the rear substrate.

Conductive epoxy (CE) may be used to electrically connect the power source to the second surface 20b and the third surface 22a of the electrochromic (EC) cell. However, CE may be an expensive solution and may not be compatible with the perimeter seal 26. For example, if the perimeter seal 26 and CE interact during the curing process, there may be significant reduction in conductivity of the CE or even loss of conductivity all together. Further, when CE is used, the chrome band at the second surface 20b that is used to hide the CE traces and the perimeter seal 26 may be relatively large.

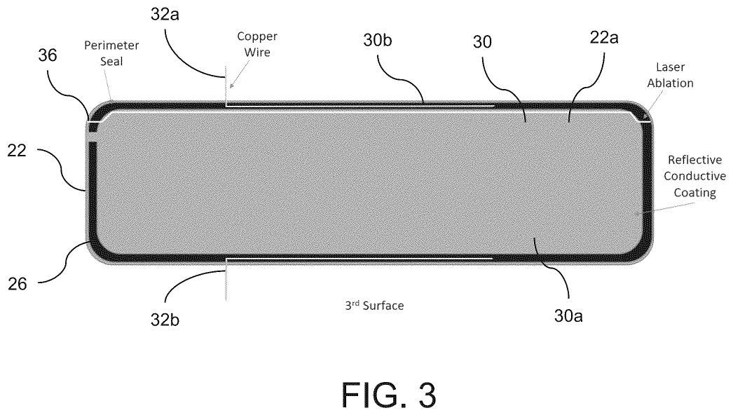

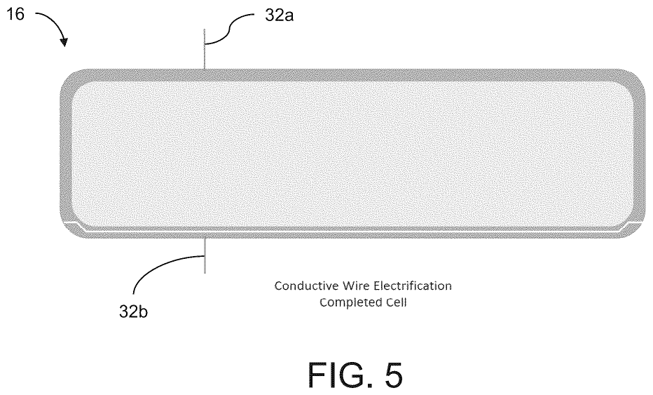

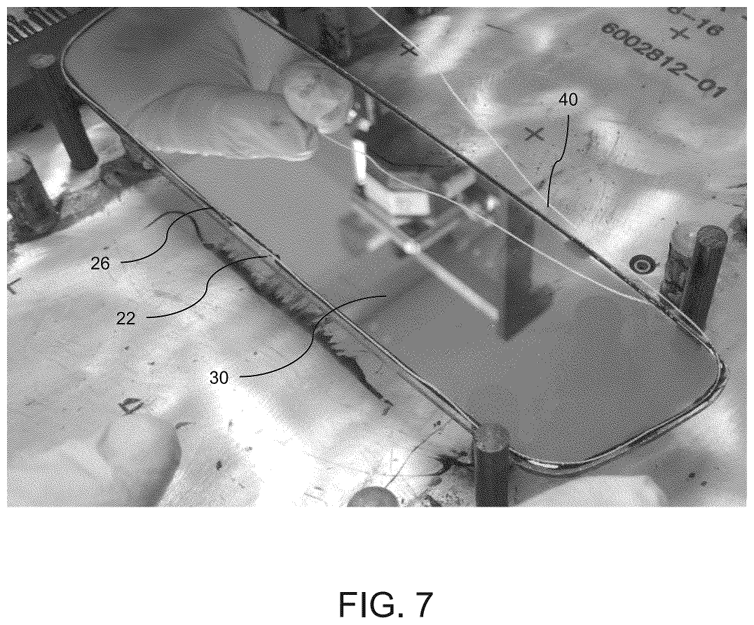

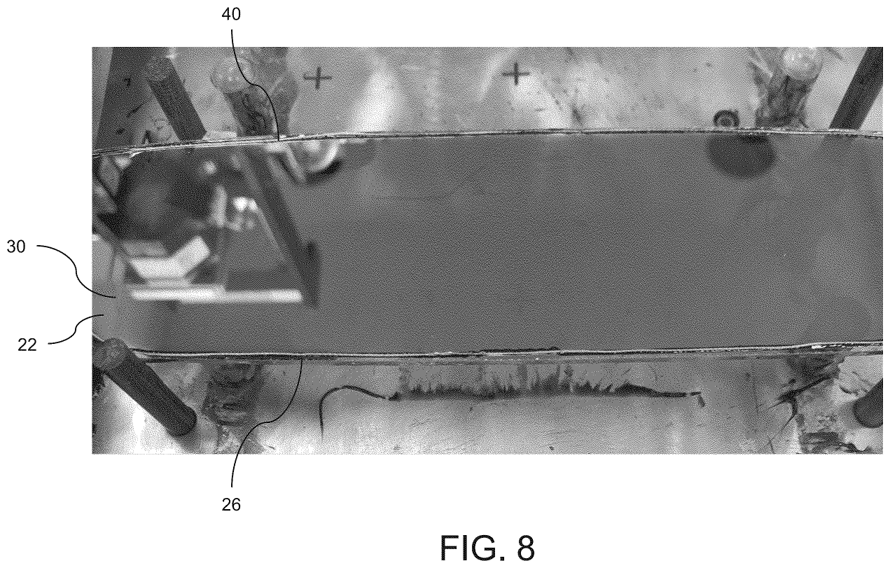

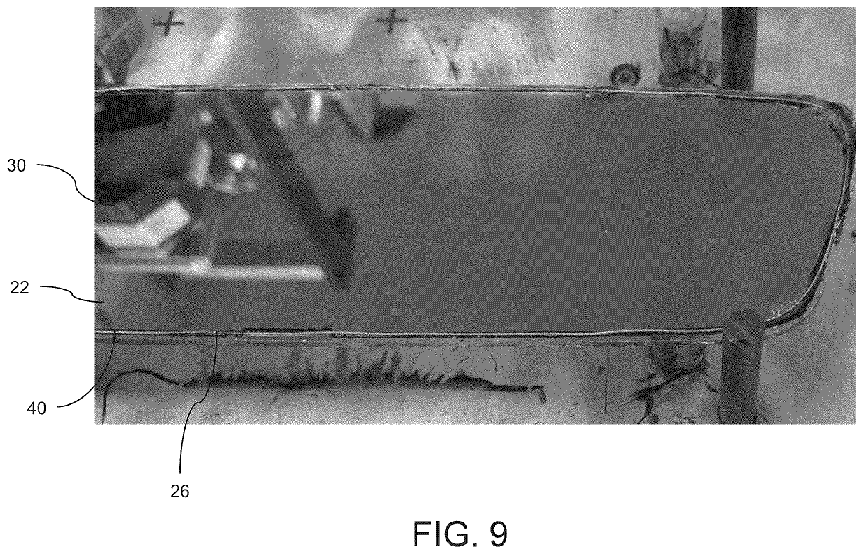

Referring to FIGS. 3-9, conductive wire electrification is an alternative to the silver based CE to provide power to the second surface 20b and the third surface 22a of the EC cell. That is, electrically conductive wires, such as copper wires, are disposed at the third surface 22a of the rear glass substrate 22 for respectively connecting the electrically conductive material 30 at the third surface 22a and the transparent conductive material 28 at the second surface 22b to a power source. For example, a first electrically conductive wire 32a is disposed along an upper peripheral edge region of the rear glass substrate 22 and a second electrically conductive wire 32b is disposed along a lower peripheral edge region of the rear glass substrate 22. The electrically conductive wires may be electrically connected to respective electrical connectors at the fourth surface 22b of the rear substrate 22 for electrically connecting the electrically conductive coatings to a power source of the vehicle. The front substrate 20 and the rear substrate 22 substantially overlap so that the respective peripheral edges of the front substrate 20 and the rear substrate 22 are generally aligned along substantially the entire perimeter of the mirror reflective element.

The first electrically conductive wire 32a is disposed along the upper peripheral edge region of the rear substrate 22 and at least partially along or within the perimeter seal 26. Similarly, the second electrically conductive wire 32b is disposed along the lower peripheral edge region of the rear substrate 22 and at least partially along or within the perimeter seal 26. The respective conductive wires extend at least partially along the length of the rear substrate 22, such as along one third of the length or more, two thirds of the length or more and the like, depending on mirror size.

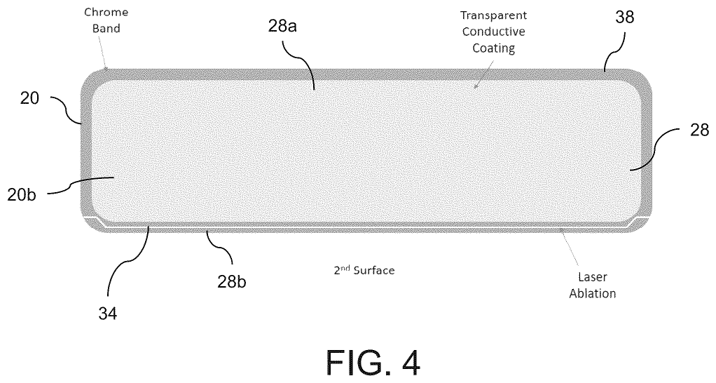

As shown in FIGS. 3 and 4, the second surface 20b and the third surface 22a include respective isolation lines (e.g., etched or ablated, such as laser ablated, isolation lines that extend through the electrically conductive coating) at the respective surface so that the isolation line is devoid of electrically conductive material. That is, a second surface isolation line 34 is laser ablated at the second surface 20b to separate the transparent conductive material 28 into separate circuits. A third surface isolation line 36 is laser ablated at the third surface 22a to separate the electrically conductive coating 30 into separate circuits for dimming the mirror reflective element. The EC cell is laser ablated at the second surface 20b and the third surface 22a to interrupt the circuit so that it does not short when connected to power.

Thus, the third surface isolation line 36 may separate the electrically conductive coating 30 so that the electrically conductive coating 30 includes a primary region 30a that spans the reflective region of the mirror reflective element and an electrical connection region 30b along the upper peripheral edge of the rear substrate 22 at which the first electrically conductive wire 32a is disposed. The second surface isolation line 34 may separate the transparent conductive coating 28 so that the transparent conductive coating 28 includes a primary region 28a that spans the reflective region of the mirror reflective element and an electrical connection region 28b along the lower peripheral edge of the front substrate 20 at which the second electrically conductive wire 32b is disposed.

The first electrically conductive wire 32a may thus be disposed at the upper peripheral edge of the mirror reflective element and electrically connected between the power source at the fourth surface 22b and the primary region 28a of the transparent conductive coating 28 at the second surface 20b. The second electrically conductive wire 32 may be disposed at the lower peripheral edge of the mirror reflective element and electrically connected between the power source at the fourth surface 22b and the primary region 30a of the electrically conductive coating 30 at the third surface 22a. Voltage (such as about 1.25 volts) is applied to the electrically conductive wires to cause the electrochromic color change of the mirror reflective element 16. The electrification of the mirror cell is thus achieved without conductive epoxy or CE along the perimeter regions.

A chrome or reflective band 38 is deposited on the second surface 20b and along the peripheral edge of the front substrate 20 to conceal or render covert the perimeter seal 26 and the electrically conductive wires. By removing CE from the assembly and using the electrically conductive wire to electrically connect the surfaces, the size of the chrome band 38 may be significantly decreased, which allows for the auto-dimming and primary reflector area of the mirror to comprise a larger portion of the mirror reflective element and allows for greater flexibility and freedom in styling and design.

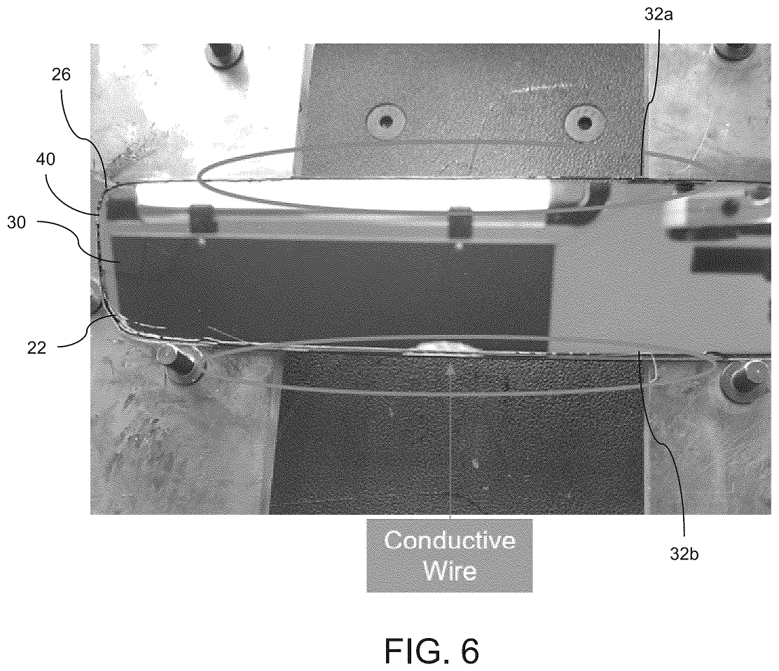

Further, and such as shown in FIGS. 6-9, a continuous fiber 40, such as nylon or polyethylene, may be disposed along the perimeter of the mirror reflective element 16, such as disposed along and at least partially within the perimeter seal 26. For example, the continuous fiber may comprise a non-conductive material and extend between ends of the first electrically conductive wire 32a and the second electrically conductive wire 32b so that the fiber and the respective wires cooperate to circumscribe the entirety of the mirror reflective element 16. The fiber and the conductive wires (which may have the same or similar diameter or thickness) may thus set the cell gap or spacing between the front substrate 20 and the second substrate 22. In other words, the fiber and conductive wires may extend end to end and cooperate to establish a uniform thickness of the perimeter seal 26 and cell gap between the first substrate 20 and the second substrate 22. Use of the continuous fiber and/or electrically conductive wires may provide greater tolerance control for the finished cell. Optionally, the perimeter seal may include spacer beads, such as glass beads and/or polymer beads to set the cell gap, where the electrically conductive wires may be slightly larger (e.g., thicker or of a greater diameter) than the diameter of the spacer beads so that the electrically conductive wires contact both the second surface 20b and the third surface 22a.

Thus, conductive wire electrification utilizes transparent conductive coatings, reflective conductive coatings, a cell gap, glass thickness, electrochromic medium (e.g., a solid polymer matrix or SPM), and a plug seal. The front and rear glass substrates of the EC cell are laser ablated on the second surface and third surface to interrupt the circuit so that it does not short when connected to power. Further, the electrically conductive wires run at least partially along the length of the mirror (such as between one third and two thirds of the length of the mirror depending on mirror size) and are placed in the upper and lower sections of the perimeter seal. After laser ablation and placement of the conductive wires, the EC cell may be assembled.

For example, the conductive wire may be dispensed along the perimeter seal after the perimeter seal is extruded onto the glass. That is, a second extruder head may co-dispense the conductive wire following the perimeter seal extruder as it deposits seal onto the glass. Optionally, the conductive wire may be mixed into the perimeter seal and both may be extruded out of the same nozzle. A cutting mechanism and automation controller may be implemented to allow only the exact amount of conductive wire to be dispensed into the perimeter seal.

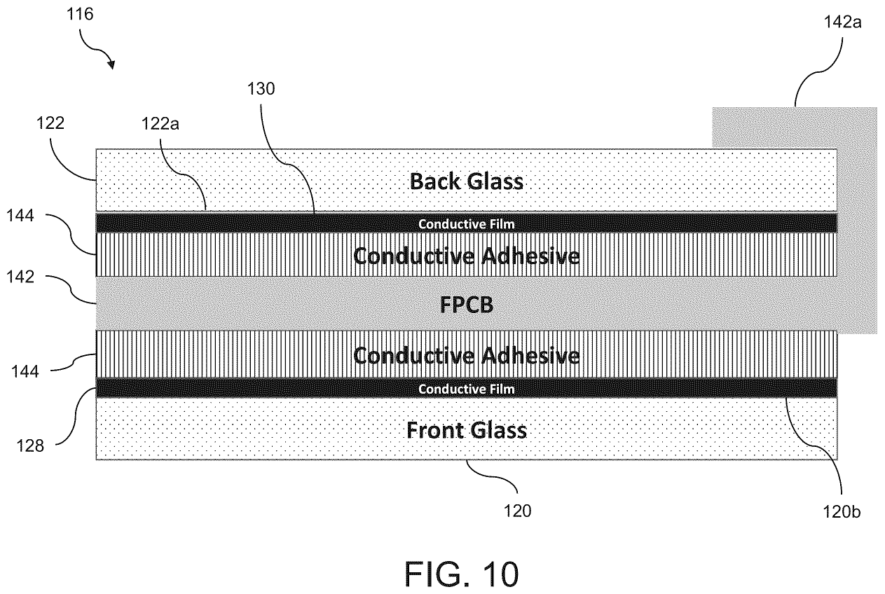

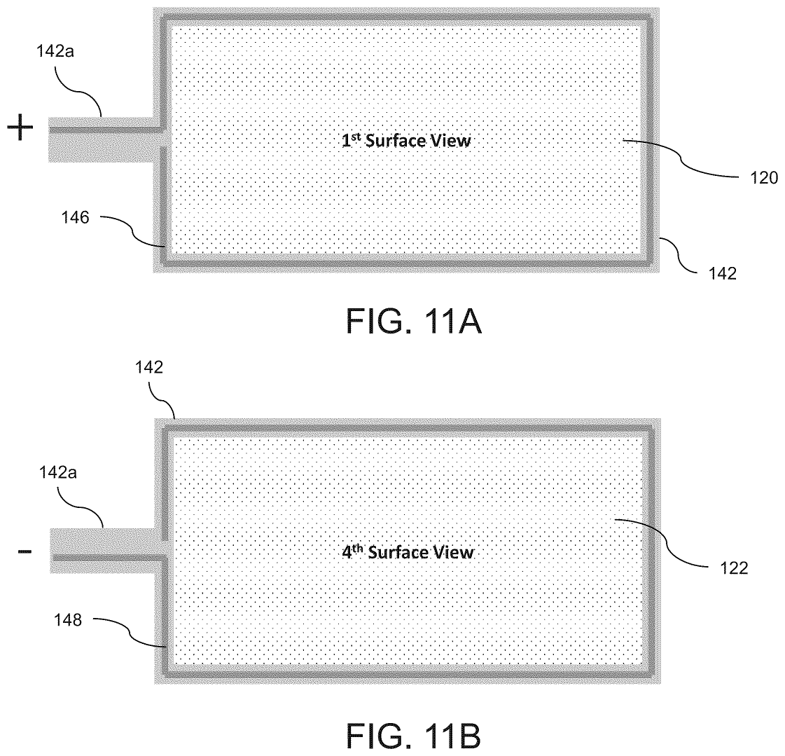

Optionally, the EC cell may be electrically connected to a power source of the vehicle via a flexible printed circuit having a connector at the fourth surface of the rear glass substrate and that extends between the front and rear glass substrate. For example, and referring to FIGS. 10-11B, an electro-optic mirror reflective element 116 may include a flexible printed circuit (FPC) 142 along the perimeter region of the EC cell for powering the EC cell. The mirror reflective element 116 includes a front glass substrate 120 and a rear glass substrate 122 with an electro-optic medium sandwiched therebetween. For example, a first conductive film 128, such as a transparent conductive coating, may be disposed at a second surface 120b of the front substrate 120, and a second conductive film 130, such as a transparent semi-conductive layer or metallic electrically conductive layer (which may include a metallic reflector or a metallic transflector), may be disposed at a third surface 122a of the rear substrate 122, with an electro-optic medium disposed between the first conductive film 128 and the second conductive film 130 and bounded by a perimeter seal at the perimeter region of the mirror reflective element 116.

The FPC 142 includes a flexible element, such as a flexible dielectric layer or substrate formed of, for example, a flexible polymer material such as a polyimide or an epoxy resin that is impregnated with a woven fiberglass, or the like, and electrically conductive traces established on the opposite sides of the flexible element. The FPC 142 is disposed about the perimeter region of the mirror reflective element 116 with a first side of the FPC 142 in contact with the first conductive film 128 and an opposite second side of the FPC 142 in contact with the second conductive film 130. For example, a first layer of a conductive adhesive 144 adhesively attaches the first side of the FPC 142 to the first conductive film 128 at the perimeter region of the mirror reflective element 116 and a second layer of the conductive adhesive 144 adhesively attaches the second side of the FPC 142 to the second conductive film 130.

As shown in FIG. 11A and 11B, a first conductive trace 146 is disposed at the first side of the FPC 142 for electrically conductively connecting to the first conductive film 128 when the first side of the FPC 142 contacts the first conductive film, and a second conductive trace 148 is disposed at the second side of the FPC 142 for electrically connecting to the second conductive film 130 when the second side of the FPC 142 contacts the second conductive film. For example, the first conductive trace 146 may comprise a positive trace (connected to a positive terminal of a power source) and the second conductive trace 148 may comprise a negative trace (connected to a negative terminal of the power source) for delivering electrical power across the electro-optic medium. A connector portion 142a of the FPC 142 may extend from the perimeter region and wrap around an edge of the rear glass substrate 122 to electrically connect the first conductive trace 146 and the second conductive trace 148 to an electrical connector at a fourth surface 122b of the rear glass substrate 122.

In some examples, the FPC 142 may be at least partially disposed within or at the perimeter seal (formed of a dielectric material) of the mirror reflective element 116, such that at portions of the perimeter region of the mirror reflective element 116, the non-conductive perimeter seal is disposed between the FPC 142 and the front substrate 120 and the rear substrate 122, and at other portions of the perimeter region, the conductive adhesive 144 is between the FPC 142 and the front substrate 120 and the rear substrate 122 to electrically conductively connect the traces of the FPC 142 to the conductive films at those perimeter region portions. In other words, the non-electrically-conductive perimeter seal extends about the perimeter region of the mirror reflective element 116 and the FPC 142 may be at least partially embedded in the perimeter seal between the front substrate 120 and the rear substrate 122. At portions of the perimeter region of the mirror reflective element, conductive adhesive 144 extends between the FPC 142 and the front substrate 120 and the rear substrate 122 to electrically conductively connect the FPC 142 to the electrically conductive films at those portions of the perimeter region.

Thus, the FPC 142 may circumscribe the mirror reflective element 116 and extend about the perimeter region of the mirror reflective element 116 between the front glass substrate 120 and the rear glass substrate 122, and thus may provide enhanced electrification of the respective electrically conductive coatings or layers when the FPC 142 is electrically powered. The first conductive trace 146 is disposed on the first side of the FPC 142 for electrically conductively connecting to the conductive film at the second surface 120b of the front glass substrate 120 and the second conductive trace 148 is disposed on the second side of the FPC 142 for electrically conductively connecting to the conductive film at the third surface 122a of the rear glass substrate 122. Conductive adhesive 144 connects the FPC 142 to the respective surfaces and holds the FPC 142 in place at the mirror reflective element 116. Accordingly, the mirror reflective element 116 comprises a stack that includes the rear glass substrate 122, the third surface conductor film 130, the first layer of the conductive adhesive 144, the FPC 142, the second layer of the conductive adhesive 144, the second surface conductor film 128, and the front glass substrate 120.

The lengths and placements of the first conductive trace 146 and the second conductive traces 148 at the FPC may be controlled and the FPC 142 is configured for the conductive traces to distribute electrical power in X and Y directions (i.e., along a longitudinal axis of the mirror reflective element and transverse to the longitudinal axis). The dielectric flexible element of the FPC 142 electrically isolates the first conductive trace 146 and the second conductive trace 148 and thus electrically isolates the first conductive film 128 and the second conductive film 130.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

As discussed above, the mirror assembly may comprise an electro-optic or electrochromic mirror assembly that includes an electro-optic or electrochromic variably reflective mirror reflective element. The perimeter edges of the reflective element may be encased or encompassed by the perimeter element or portion of the bezel portion to conceal and contain and envelop the perimeter edges of the substrates and the perimeter seal disposed therebetween. The variably reflective mirror reflective element of the mirror assembly may utilize aspects of the mirror reflective elements described in commonly assigned U.S. Pat. Nos. 7,626,749; 7,274,501; 7,255,451; 7,195,381; 7,184,190; 6,690,268; 5,140,455; 5,151,816; 6,178,034; 6,154,306; 6,002,544; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, and/or U.S. Publication No. US-2022-0371513, which are hereby incorporated herein by reference in their entireties.

The perimeter band may include an opaque or substantially opaque or hiding perimeter layer or coating or band disposed around a perimeter edge region of the front substrate (such as at a perimeter region of the rear or second surface of the front substrate) to conceal or hide or the perimeter seal from viewing by the driver of the vehicle when the mirror assembly is normally mounted in the vehicle. Such a hiding layer or perimeter band may be reflective or not reflective and may utilize aspects of the perimeter bands and mirror assemblies described in U.S. Pat. Nos. 5,066,112; 7,626,749; 7,274,501; 7,184,190; 7,255,451; 8,508,831 and/or 8,730,553, which are all hereby incorporated herein by reference in their entireties. Optionally, the perimeter band may comprise a chrome/chromium coating or metallic coating and/or may comprise a chrome/chromium or metallic coating that has a reduced reflectance, such as by using an oxidized chrome coating or chromium oxide coating or “black chrome” coating or the like (such as by utilizing aspects of the mirror assemblies described in U.S. Pat. No. 7,184,190 and/or 7,255,451, which are hereby incorporated herein by reference in their entireties). Optionally, other opaque or substantially opaque coatings or bands may be implemented.

Changes and modifications in the specifically described embodiments may be carried out without departing from the principles of the present invention, which is intended to be limited only by the scope of the appended claims as interpreted according to the principles of patent law.

1. A vehicular electrochromic interior rearview mirror assembly, the vehicular electrochromic interior rearview mirror assembly comprising:
a mirror head adjustable relative to a mounting base, wherein the mounting base is configured to mount the vehicular electrochromic interior rearview mirror assembly at an interior portion of an interior cabin of a vehicle;
wherein the mirror head accommodates an electrochromic mirror reflective element;
wherein, with the vehicular electrochromic interior rearview mirror assembly mounted at the interior portion of the interior cabin of the vehicle, the mirror head is adjustable by a driver of the vehicle to set a rearward view for the driver;
wherein the electrochromic mirror reflective element comprises a front glass substrate having a first side and a second side separated from the first side by a thickness of the front glass substrate;
wherein the electrochromic mirror reflective element comprises a rear glass substrate having a third side and a fourth side separated from the third side by a thickness of the rear glass substrate;
wherein a transparent electrically conductive coating is disposed at the second side of the front glass substrate;
wherein an electrically conductive coating is disposed at the third side of the rear glass substrate, and wherein the electrically conductive coating comprises a mirror reflector;
wherein the electrochromic mirror reflective element comprises an electrochromic medium disposed between the second side of the front glass substrate and the third side of the rear glass substrate and bounded by a perimeter seal, and wherein the perimeter seal extends along a peripheral edge region of the electrochromic mirror reflective element;
wherein the electrochromic medium is in electrically conductive contact with the transparent electrically conductive coating disposed at the second side of the front glass substrate and with the electrically conductive coating disposed at the third side of the rear glass substrate;
wherein a first electrically conductive connector extends along a first portion of the peripheral edge region of the electrochromic mirror reflective element and electrically conductively connects the transparent electrically conductive coating to a first electrical connector at the fourth side of the rear glass substrate;
wherein a second electrically conductive connector extends along a second portion of the peripheral edge region of the electrochromic mirror reflective element and electrically conductively connects the electrically conductive coating to a second electrical connector at the fourth side of the rear glass substrate; and
wherein the first electrically conductive connector comprises a first electrically conductive element disposed at least partially within the perimeter seal along the first portion of the peripheral edge region of the electrochromic mirror reflective element, and wherein the second electrically conductive connector comprises a second electrically conductive element disposed at least partially within the perimeter seal along the second portion of the peripheral edge region of the electrochromic mirror reflective element, and wherein the first portion of the perimeter seal is spaced from the second portion of the perimeter seal.

2. The vehicular electrochromic interior rearview mirror assembly of claim 1, wherein a first region of the transparent electrically conductive coating is electrically isolated from a second region of the transparent electrically conductive coating, and wherein a first region of the electrically conductive coating is electrically isolated from a second region of the electrically conductive coating, and wherein the first electrically conductive connector electrically conductively connects to the first region of the transparent electrically conductive coating, and wherein the second electrically conductive connector electrically conductively connects to the first region of the electrically conductive coating.

3. The vehicular electrochromic interior rearview mirror assembly of claim 2, wherein the first region of the transparent electrically conductive coating and the first region of the electrically conductive coating are spaced from one another, and wherein the second region of the transparent electrically conductive coating and the second region of the electrically conductive coating at least partially overlap one another.

4. The vehicular electrochromic interior rearview mirror assembly of claim 2, wherein a first ablation line is formed along the transparent electrically conductive coating to electrically isolate the first region of the transparent electrically conductive coating and the second region of the transparent electrically conductive coating, and wherein a second ablation line is formed along the electrically conductive coating to electrically isolate the first region of the electrically conductive coating and the second region of the electrically conductive coating.

5. The vehicular electrochromic interior rearview mirror assembly of claim 1, wherein a hiding layer is disposed at the second side of the front glass substrate along the peripheral edge region of the electrochromic mirror reflective element.

6. The vehicular electrochromic interior rearview mirror assembly of claim 1, wherein the first electrically conductive element comprises an electrically conductive wire and the second electrically conductive element comprises an electrically conductive wire.

7. The vehicular electrochromic interior rearview mirror assembly of claim 1, wherein a non-conductive fiber extends along the peripheral edge region of the electrochromic mirror reflective element at least between the first portion of the peripheral edge region and the second portion of the peripheral edge region.

8. The vehicular electrochromic interior rearview mirror assembly of claim 7, wherein the first electrically conductive connector, the second electrically conductive connector and the non-conductive fiber cooperate to at least partially circumscribe the peripheral edge region of the electrochromic mirror reflective element.

9. A vehicular electrochromic interior rearview mirror assembly, the vehicular electrochromic interior rearview mirror assembly comprising:
a mirror head adjustable relative to a mounting base, wherein the mounting base is configured to mount the vehicular electrochromic interior rearview mirror assembly at an interior portion of an interior cabin of a vehicle;
wherein the mirror head accommodates an electrochromic mirror reflective element;
wherein, with the vehicular electrochromic interior rearview mirror assembly mounted at the interior portion of the interior cabin of the vehicle, the mirror head is adjustable by a driver of the vehicle to set a rearward view for the driver;
wherein the electrochromic mirror reflective element comprises a front glass substrate having a first side and a second side separated from the first side by a thickness of the front glass substrate;
wherein the electrochromic mirror reflective element comprises a rear glass substrate having a third side and a fourth side separated from the third side by a thickness of the rear glass substrate;
wherein a mirror reflector is disposed at the fourth side of the rear glass substrate;
wherein a transparent electrically conductive coating is disposed at the second side of the front glass substrate;
wherein an electrically conductive coating is disposed at the third side of the rear glass substrate;
wherein the electrochromic mirror reflective element comprises an electrochromic medium disposed between the second side of the front glass substrate and the third side of the rear glass substrate and bounded by a perimeter seal, and wherein the perimeter seal extends along a peripheral edge region of the electrochromic mirror reflective element;
wherein the electrochromic medium is in electrically conductive contact with the transparent electrically conductive coating disposed at the second side of the front glass substrate and with the electrically conductive coating disposed at the third side of the rear glass substrate;
wherein a first electrically conductive connector extends along a first portion of the peripheral edge region of the electrochromic mirror reflective element and electrically conductively connects the transparent electrically conductive coating to a first electrical connector at the fourth side of the rear glass substrate;
wherein a second electrically conductive connector extends along a second portion of the peripheral edge region of the electrochromic mirror reflective element and electrically conductively connects the electrically conductive coating to a second electrical connector at the fourth side of the rear glass substrate;
wherein a first region of the transparent electrically conductive coating is electrically isolated from a second region of the transparent electrically conductive coating, and wherein a first region of the electrically conductive coating is electrically isolated from a second region of the electrically conductive coating, and wherein the first electrically conductive connector electrically conductively connects to the first region of the transparent electrically conductive coating, and wherein the second electrically conductive connector electrically conductively connects to the first region of the electrically conductive coating; and
wherein the first electrically conductive connector comprises a first electrically conductive element disposed at least partially within the perimeter seal along the first portion of the peripheral edge region of the electrochromic mirror reflective element, and wherein the second electrically conductive connector comprises a second electrically conductive element disposed at least partially within the perimeter seal along the second portion of the peripheral edge region of the electrochromic mirror reflective element, and wherein the first portion of the perimeter seal is spaced from the second portion of the perimeter seal.

10. The vehicular electrochromic interior rearview mirror assembly of claim 9, wherein the first region of the transparent electrically conductive coating and the first region of the electrically conductive coating are spaced from one another, and wherein the second region of the transparent electrically conductive coating and the second region of the electrically conductive coating at least partially overlap one another.

11. The vehicular electrochromic interior rearview mirror assembly of claim 9, wherein a first ablation line is formed along the transparent electrically conductive coating to electrically isolate the first region of the transparent electrically conductive coating and the second region of the transparent electrically conductive coating, and wherein a second ablation line is formed along the electrically conductive coating to electrically isolate the first region of the electrically conductive coating and the second region of the electrically conductive coating.

12. The vehicular electrochromic interior rearview mirror assembly of claim 9, wherein a hiding layer is disposed at the second side of the front glass substrate along the peripheral edge region of the electrochromic mirror reflective element.

13. The vehicular electrochromic interior rearview mirror assembly of claim 9, wherein the first electrically conductive element comprises an electrically conductive wire and the second electrically conductive element comprises an electrically conductive wire.

14. The vehicular electrochromic interior rearview mirror assembly of claim 9, wherein a non-conductive fiber extends along the peripheral edge region of the electrochromic mirror reflective element at least between the first portion of the peripheral edge region and the second portion of the peripheral edge region.

15. The vehicular electrochromic interior rearview mirror assembly of claim 14, wherein the first electrically conductive connector, the second electrically conductive connector and the non-conductive fiber cooperate to at least partially circumscribe the peripheral edge region of the electrochromic mirror reflective element.

16. A vehicular electrochromic interior rearview mirror assembly, the vehicular electrochromic interior rearview mirror assembly comprising:
a mirror head adjustable relative to a mounting base, wherein the mounting base is configured to mount the vehicular electrochromic interior rearview mirror assembly at an interior portion of an interior cabin of a vehicle;
wherein the mirror head accommodates an electrochromic mirror reflective element;
wherein, with the vehicular electrochromic interior rearview mirror assembly mounted at the interior portion of the interior cabin of the vehicle, the mirror head is adjustable by a driver of the vehicle to set a rearward view for the driver;
wherein the electrochromic mirror reflective element comprises a front glass substrate having a first side and a second side separated from the first side by a thickness of the front glass substrate;
wherein the electrochromic mirror reflective element comprises a rear glass substrate having a third side and a fourth side separated from the third side by a thickness of the rear glass substrate;
wherein a mirror reflector is disposed at the rear glass substrate;
wherein a transparent electrically conductive coating is disposed at the second side of the front glass substrate;
wherein an electrically conductive coating is disposed at the third side of the rear glass substrate;
wherein the electrochromic mirror reflective element comprises an electrochromic medium disposed between the second side of the front glass substrate and the third side of the rear glass substrate and bounded by a perimeter seal, and wherein the perimeter seal extends along a peripheral edge region of the electrochromic mirror reflective element;
wherein the electrochromic medium is in electrically conductive contact with the transparent electrically conductive coating disposed at the second side of the front glass substrate and with the electrically conductive coating disposed at the third side of the rear glass substrate;
a flexible printed circuit (FPC) disposed along the peripheral edge region of the electrochromic mirror reflective element, wherein the FPC includes (i) a first electrically conductive element disposed at a first side of the FPC and (ii) a second electrically conductive element disposed at a second side of the FPC that is opposite the first side of the FPC, and wherein the first electrically conductive element is spaced from and electrically isolated from the second electrically conductive element;
wherein the first electrically conductive element extends along the peripheral edge region of the electrochromic mirror reflective element and electrically conductively connects the transparent electrically conductive coating to a first electrical connector at the fourth side of the rear glass substrate; and
wherein the second electrically conductive element extends along the peripheral edge region of the electrochromic mirror reflective element and electrically conductively connects the electrically conductive coating to a second electrical connector at the fourth side of the rear glass substrate.

17. The vehicular electrochromic interior rearview mirror assembly of claim 16, wherein the first electrically conductive element and the second electrically conductive element each comprise a respective conductive trace extending along a non-electrically-conducting flexible element of the FPC.

18. The vehicular electrochromic interior rearview mirror assembly of claim 16, wherein a first layer of a conductive adhesive extends between and electrically conductively connects the first electrically conductive element and the transparent electrically conductive coating, and wherein a second layer of the conductive adhesive extends between and electrically conductively connects the second electrically conductive element and the electrically conductive coating.

19. The vehicular electrochromic interior rearview mirror assembly of claim 16, wherein the first electrically conductive element at least partially circumscribes the electrochromic mirror reflective element along the peripheral edge region, and wherein the second electrically conductive element at least partially circumscribes the electrochromic mirror reflective element along the peripheral edge region.

20. The vehicular electrochromic interior rearview mirror assembly of claim 16, wherein a portion of the FPC extends along the fourth side of the rear glass substrate to allow for electrical connection (i) between the first electrical connector and the first electrically conductive element and (ii) between the second electrical connector and the second electrically conductive element.

21. The vehicular electrochromic interior rearview mirror assembly of claim 16, wherein the first electrically conductive element is disposed at least partially within the perimeter seal along the peripheral edge region of the electrochromic mirror reflective element, and wherein the second electrically conductive element is disposed at least partially within the perimeter seal along the peripheral edge region of the electrochromic mirror reflective element.

22. The vehicular electrochromic interior rearview mirror assembly of claim 16, wherein the electrically conductive coating comprises the mirror reflector.

23. The vehicular electrochromic interior rearview mirror assembly of claim 16, wherein the mirror reflector is disposed at the fourth side of the rear glass substrate.
